(19) United States
(12) Patent Application Publication
(10) Pub. No.: US 2013/0004141 A1
(43) Pub. Date: Jan. 3, 2013

(54) Method and Device for Locating Video Clips

(75) Inventors: Yunsheng Wu, Shenzhen (CN); Lingling Zou, Shenzhen (CN)

(73) Assignee: Tencent Technology (Shenzhen) Company Ltd., Shenzhen (CN)

(21) Appl. No.: 13/634,671

(22) PCT Filed: Aug. 30, 2011
(86) PCT No.: PCT/CN2011/079089

§ 371 Date: Sep. 13, 2012

(30) Foreign Application Priority Data
Aug. 31, 2010 (CN) 201010271776..9

(51) Int. Cl. H04N 9/80

(52) U.S. Cl. 386/241; 386/244

(57) ABSTRACT

A example of the present invention disclose a method for locating video clips, comprises receiving target dialogue a user requests to search in the video; determining subtitle data that matches the target dialogue according to a preset matching rule; and locate the video clip corresponding to the target dialogue in the video according to the matched subtitle data. Another example of the present invention discloses a device for locating video clips. Adopting examples of the present invention, the user only needs to input a desirable dialogue to directly watch video starting from the video clip corresponding to the dialogue, so that the user does not have to search for the desirable video manually, and the user's experience of watching a video is improved.

### FIELD OF THE TECHNOLOGY

The present invention relates to video locating technique, especially to a method and a device for locating video clips.

### BACKGROUND OF THE INVENTION

Nowadays, it has become a popular entertaining way for people to watch videos on a terminal, like seeing a movie on a computer. Most videos have dialogues and, when the video is being played, subtitles corresponding to the dialogues will be displayed at the same time. Especially dialogues in many movies are provided with subtitles correspondingly. A subtitle file is usually used to store subtitle-related data, such as timeline, content and format of the subtitle. A playing tool on the terminal loads a subtitle file while loading a video and, when playing the video, adds the subtitle content to the video according to the timeline, so that the user can see a video with the corresponding subtitle.

After seeing a certain video, the user is usually impressed by some dialogues in the video. When the user wants to see video clips corresponding to these dialogues once again, or to cut out video clips corresponding to these dialogues, since there is no scheme in the prior art to locate a video clip according to a dialogue in a video yet, it's very difficult for the user to find the video clip fast and effectively.

Under common condition, the user needs to search the video clip by clip, or determine a probable position of the desirable video clip according to his memory before searching the video clip by clip, until the user hears corresponding dialogue or sees corresponding subtitle, before finding the desirable video clip in the video positively. It is a very tedious course to search for a video clip, and the user may not find a desirable video clip as always after searching for a period of time, which caused a waste of time and a bad video watching experience for the user.

### SUMMARY OF THE INVENTION

An example of the present invention provides a method for locating video clips, so as to locate the video clip corresponding to a dialogue fast and conveniently according to the dialogue directly, thus the user's video watching experience can be improved.

The method for locating video clips comprises:

receiving target dialogue to be found in a video from a user; determining subtitle data matching the target dialogue according to a preset matching rule; and

locating the video clip corresponding to the said target dialogue in the said video according to the said matched subtitle data.

Another example of the present invention provides a device for locating video clips, so as to locate the video clip corresponding to a dialogue fast and conveniently according to the dialogue directly, and the user's video watching experience can be improved.

The device for locating video clips comprises:

an interacting module, to receive target dialogue to be found in a video from a user;

a matching module, to determine subtitle data that matches the target dialogue according to a preset matching rule; and

a locating module, to locate the video clip corresponding to the target dialogue in the video according to the matched subtitle data.

It can be seen from the above scheme that, in the method and device for locating video clips provided by examples of the present invention, the user only needs to input a desirable dialogue to directly watch video starting from the video clip corresponding to the said dialogue, so that the user does not have to search for the desirable video manually, and the user's experience of watching a video is improved.

### BRIEF DESCRIPTION OF THE DRAWINGS

FIG. 1 is a flowchart illustrating the method for locating video clips according to an example of the present invention;

FIG. 2 is a flowchart illustrating the method for locating video clips according to another example of the present invention;

FIG. 3 is a diagram illustrating user interface according to an example of the present invention;

FIG. 4 is a diagram illustrating user interface for displaying the matched subtitle content according to an example of the present invention;

FIG. 5 is a diagram illustrating structure of the device for locating video clips according to an example of the present invention;

FIG. 6 is a diagram illustrating structure of the device for locating video clips according to another example of the present invention.

### DETAILED DESCRIPTION OF THE INVENTION

To make the object, technical scheme and advantages of the present invention clearer, examples of the present invention will be described in further detail.

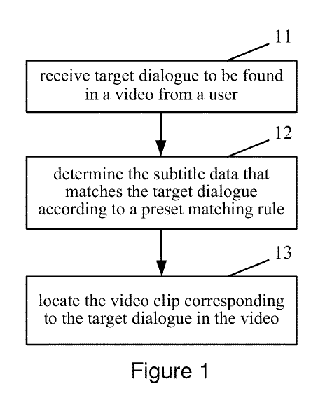

FIG. 1 shows the method for locating video clips according to an example of the present invention. As shown in FIG. 1, the method for locating video clips comprises the following steps.

Block 11, receiving target dialogue to be found in a video from a user.

When the user wants to found a video clip corresponding to a certain dialogue in a video, the user can input this dialogue through a user interface. In this example of the present invention, the dialogue that the user wants to find is called a target dialogue. The device for locating video clips receives a target dialogue input by a user through a user interface.

Block 12, according to a preset matching rule, determining the subtitle data that matches the target dialogue.

In this block, the device for locating video clips can search for the subtitle data matching the target dialogue in the subtitle file corresponding to this video. In the subtitle file, a piece of subtitle data comprises at least subtitle content and a point corresponding to this subtitle content, namely the time at which this subtitle content is showed.

The device for locating video clips compares the target dialogue with subtitle content in each piece of subtitle data according to the preset matching rule, searches the subtitle content matching the target dialogue, and directly determines that subtitle data which the matching subtitle content belongs is the subtitle data matching the target dialogue.

In this example of the present invention, a subtitle file can be a plug-in subtitle file or be a readable embedded subtitle, such as an embedded subtitle in a MKV file. Therefore, examples of the present invention can be implemented to locate video chips whose corresponding subtitle file can be searched.

Therein, the preset matching rule can be an exact match rule, or a fuzzy match rule, or a close match rule. In practical applications, in order to find subtitle data corresponding to the target dialogue, except the above mentioned existing matching algorithms, other algorithms for subtitle comparing and matching can also be adopted, which is not limited by examples of the present invention.

In practical application, in order to make sure that the matched subtitle data corresponds to the dialogue the user wishes to find, the device for locating video clips can show the found subtitle data to the user, such as show subtitle content and time point of a piece of subtitle data to the user, or only show subtitle content to the user. The user can select and confirm via a user interface. After receiving the user's acknowledgement message, the device for locating video clips then determines the subtitle data corresponding to the target dialogue according to the subtitle data or subtitle content which the user chooses.

Especially, when there are multiple pieces of subtitle data matching the preset matching rule, the user can preview the multiple pieces of subtitle data first, and chooses a desirable piece of subtitle data thereof. Then, the device for locating video clips can well satisfy the user's request, and finds out the video clip the user wishes to see.

Block 13, according to the matched subtitle data, locating the video clip corresponding to the target dialogue in the video.

Because the subtitle data comprise time points corresponding to subtitle content, in this block, the time point from the matched subtitle data is first obtained, and then the video clip corresponding to the target dialogue according to the time point is located.

In this example of the present invention, the device for locating video clips may further start playing the video from the video clip. To make the user have a better video seeing experience, the device for locating video clips may start playing the video several seconds in advance of the video clip.

In the above example, the subtitle data is loaded in advance. If the subtitle of a video is not loaded when a user input a target dialogue, the device for locating video clips according to the example of the present invention may further search locally and/or the network to find and load the subtitle data.

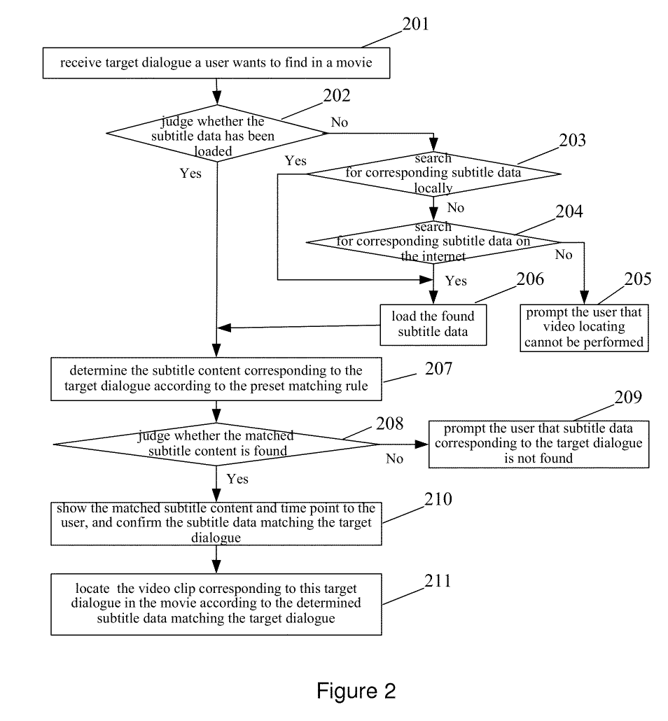

The method for locating video clips will be described in detail taking a movie for example. FIG. 2 shows the method for locating video clips according to another example of the present invention. As shown in FIG. 2, the method for locating video clips comprises the following steps.

Block 201, receiving target dialogue that a user wants to find in a movie.

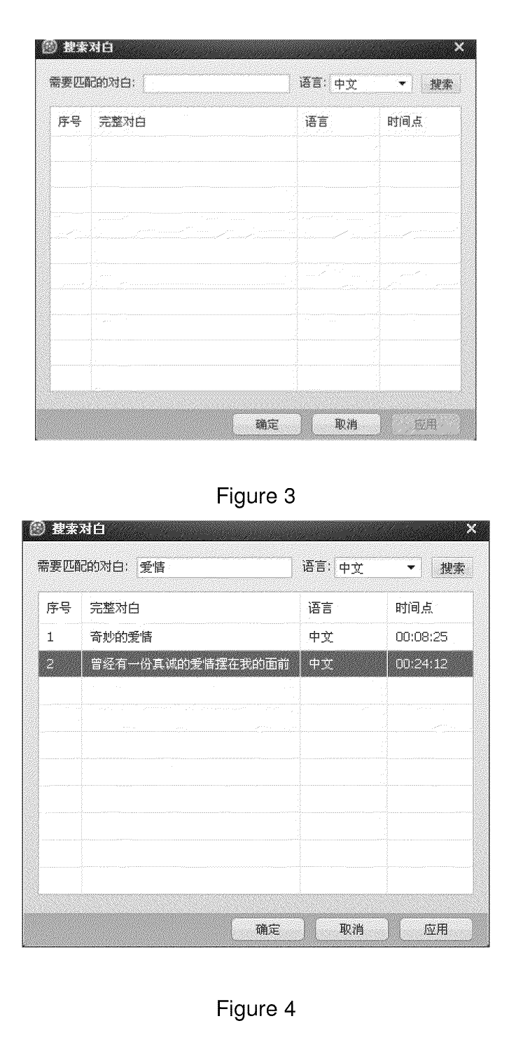

In this block, it is assumed that the movie the user is to search is “A Chinese Odyssey”. The user inputs a target dialogue showing in this movie through the user interface. This target dialogue can be a word or a phrase, or a segment of words. While inputting a target dialogue, the user can also choose a language type for the target dialogue, so as to find a subtitle. FIG. 3 is a diagram illustrating the user interface according to the present example. The target dialogue the user inputs via the user interface shown in FIG. 3 is “love”.

Block 202, judging whether the subtitle data has been loaded. If the subtitle data has been loaded, proceeds to block 207, if the subtitle data has not been loaded yet, proceeds to block 203.

Usually, the subtitle data is stored in a subtitle file. In this block, the process can be as judging whether the subtitle file has been loaded.

Block 203, searching for the subtitle data corresponding to the movie locally. When the subtitle data corresponding to the movie is found locally, proceeds to block 206. If the subtitle data corresponding to the movie can not be found locally, proceeds to block 204.

Similarly, in this block, it is also feasible to directly search for the subtitle file corresponding to the movie locally.

Block 204, searching for the subtitle data corresponding to the movie on the Internet.

In this block, the device for locating video clips can search on the network, such as Internet or local area network, to find subtitle data or subtitle file corresponding to the movie. Subtitle files that can be found on the network include subtitle files for online use. When the subtitle data corresponding to the movie are found on the network, proceeds to block 206, when the subtitle data corresponding to the movie are not found on the network, proceeds to block 205.

In practical applications, it is feasible to execute block 203 or block 204 only, which does not affect applying this embodiment of the present invention.

Block 205, prompting the user that video locating cannot be performed.

The device for locating video clips can prompt the user through a prompt box. By now, the current process is ended.

Block 206, loading the found subtitle data.

In this block, the device for locating video clips can analyze subtitle content in the subtitle data and time point corresponding to this subtitle content, and store the subtitle content and time point in the memory.

Block 207, according to a preset matching rule, determining the subtitle content corresponding to the target dialogue.

In this example, the preset matching rule is accurate matching rule, and the device for locating video clips takes the word “love” as the key word to search for a subtitle content matching “love” accurately in the loaded subtitle data.

Block 208, when the matched subtitle content is found, proceeds to block 210, or if the matched subtitle content can not be found, proceeds to block 209.

Block 209, prompting the user subtitle data corresponding to the target dialogue can not be found.

The device for locating video clips can prompt the user through a prompt box, by now, current process is ended. The user can re-input a new target dialogue, for the device for locating video clips to match, which is not to be repeated here.

Block 210, showing the matched subtitle content and the time point to the user, and confirming the subtitle data matching the target dialogue.

In this example, the matched subtitle contents includes “wonderful love” and “once there was a true love at my hand”, corresponding to two different time points respectively. So the device for locating video clips shows the two matched subtitle contents and matched time points on the user interface, as shown in FIG. 4. The user can choose the dialogue he wishes to view via the user interface, and tell the device for locating video clips by clicking the confirm key on the user interface, so that the device for locating video clips can determine the subtitle data matching the target dialogue. In this example, the user chooses the subtitle content of “once there was a true love at my hand”.

In addition, in practical applications, the device for locating video clips can, without showing the found subtitle data to the user, directly take the subtitle data of the subtitle content with the most matching degree as the subtitle data matching the target dialogue, and then proceeds to block 211.

Block 211, according to the determined subtitle data matching the target dialogue, locating the video clip corresponding to this target dialogue in the movie.

In this example, according to the time point corresponding to the subtitle content in the subtitle data, the device for locating video clips can locate the video clip corresponding to the target dialogue. For example, in this example, time point corresponding to the dialogue “once there was a true love at my hand” is 00:24:12, namely this video clip presents at 24 minutes and 12 seconds, therefore the device for locating video clips should locate at 24 minutes and 12 seconds in the movie. So the user can directly see the movie clip corresponding to the target dialogue, if only the user chooses to play the movie, the user can watch the movie starting from the movie clip.

To provide a better video experience for the user, the device for locating video clips may locate the movie clip several seconds in advance, such as locate the move clip at 24 minutes and 7 seconds.

Therefore, in the method for locating video clips provided by the example of the present invention, the user only needs to input certain dialogues or certain words in the dialogues that he wants to see in the video, the user can watch the video clip corresponding to the desirable dialogue fast and directly, so that the user's request of watching is satisfied, without having to search for the desirable video manually, and the user's experience of watching a video is improved.

Example of the present invention also provides a device for locating video clips, which can perform the method for locating video clips.

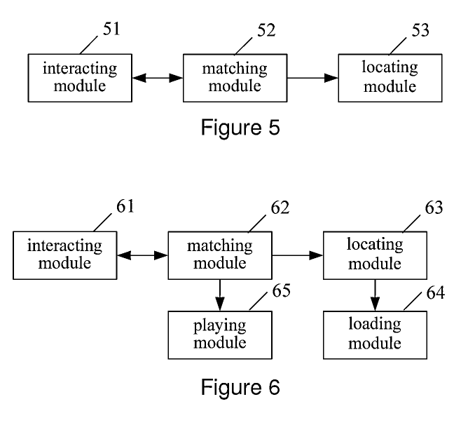

FIG. 5 is a diagram illustrating structure of the device for locating video clips according to an example of the present invention. As shown in FIG. 5, this device for locating video clips comprises an interacting module 51, a matching module 52 and a locating module 53.

The interacting module 51 is used to receive the target dialogue to be found in the video. The matching module 52 is used to determine the subtitle data matching the target dialogue according to a preset matching rule. The locating module 53 is used to locate the video clip corresponding to the target dialogue in the video according to the matched subtitle data.

In the example of the present invention, subtitle data comprise subtitle content and time point corresponding to the subtitle content.

The matching module 52 can directly determine that the subtitle data that the subtitle content belongs is the subtitle data matching the target dialogue; or the matching module 52 can send at least one subtitle data that the matched subtitle content belongs to the interacting module 51, the interacting module 51 displays the received subtitle data to the user, and acquires the subtitle data that the user chooses, and then the matching module 52 takes the subtitle data the user chooses as the subtitle data matching this target dialogue; or, the matching module 52 sends at least one matched subtitle content to the interacting module 51, the interacting module 51 displays the subtitle content to the user, and acquires the subtitle content the user chooses, and then the matching module 52 takes the subtitle data that the subtitle content the user chooses is in as the subtitle data matching this target dialogue.

The locating module 53 comprises a time point acquiring submodule and position determining submodule. The time point acquiring submodule is used to acquire time points in the matched subtitle data, and position determining submodule is used to locate the video clip corresponding to the target dialogue in this video according to the time points.

FIG. 6 a diagram illustrating structure of the device for locating video clips according to another example of the present invention. As shown in FIG. 6, this device for locating video clips comprises an interacting module 61, a matching module 62, a locating module 63, a playing module 64 and a loading module 65.

Therein, the interacting module 61, the matching module 62 and the locating module 63 have the same functions as those of the interacting module 51, the matching module 52 and the locating module 53 shown in FIG. 5, and the functions are not to be repeated here.

The playing module 64 is used to start playing the video from the video clip. In order to provide a better video experience for the user, playing module 64 can start playing the video several seconds in advance of the video clip.

The loading module 65 is used to search for subtitle data corresponding to the vice locally or on the network, and load the found subtitle data, and the matching module 62 searches the loaded subtitle data for subtitle data corresponding to target dialogue.

In the example of the present invention, the device for locating video clips can work together with the existing video playing tools, provide video locating function while providing video playing function, and can be a separate video playing tool to provide video locating function for the user.

So, by using the device for locating video clips provided by an example of the present invention, the user only needs to enter certain dialogues or certain words in the dialogues that he wants to see in the video, the user can watch the video clip corresponding to the desirable dialogue fast and directly, so that the user's request of watching is satisfied, without having to search for the desirable video manually, and the user's experience of watching a video is improved.

The above description gives just examples of the present invention, not used to limit protection scope of the present invention. These examples according to the present invention can be properly modified during specific implementation processes, so as to adapt to specific requirement of specific situation. It can be understood that, specific examples described in the present invention are just for demonstration, not used to limit protection scope of the present invention.

1. A method for locating video clips, comprising:
receiving target dialogue to be found in a video from a user;
determining subtitle data matching the target dialogue according to a preset matching rule; and
locating the video clip corresponding to the target dialogue in the video according to the subtitle data matching the target dialogue.

2. The method according to claim 1, wherein the subtitle data comprises: subtitle content and time point corresponding to the subtitle content.

3. The method according to claim 2, wherein determining subtitle data matching the target dialogue comprises:
determining subtitle content matching the target dialogue; and
determining the subtitle data that the matching subtitle content belongs as the subtitle data matching the target dialogue.

4. The method according to claim 2, wherein locating the video clip corresponding to the target dialogue in the video according to the matched subtitle data, comprises:
acquiring time points in the subtitle data matching the target dialogue;
locating the video clip corresponding to the target dialogue in the video according to the time points.

5. The method according to claim 1, further comprising: starting playing the video from the video clip.

6. The method according to claim 1, further comprising:
if subtitle data has not been loaded, searching locally and/or in the network for the subtitle data corresponding to the video; and
loading the found subtitle data.

7. A device for locating video clips, comprising:
an interacting module, to receive target dialogue to be found in a video from a user;
a matching module, to determine subtitle data matching the target dialogue according to a preset matching rule; and
a locating module, to locate the video clip corresponding to the target dialogue in the video according to the subtitle data matching the target dialogue.

8. The device according to claim 7, wherein the subtitle data comprises: subtitle content and time point corresponding to the subtitle contents.

9. The device according to claim 8, wherein the matching module is further to determine subtitle contents corresponding to the target dialogue;
the interacting module is further to display at least one of the determined contents to the user, the matching module is further to determine the subtitle data corresponding to a subtitle content selected by the user as the subtitle data corresponding to the target dialogue.

10. The device according to claim 8, wherein the locating module comprises:
a time point acquiring submodule, to acquire time points in the matched subtitle data; and
a position determining submodule, to locate the video clip corresponding to the target dialogue in this video according to the time points.

11. The device according to claim 7, further comprising:
a playing module, to start playing the video from the video clip.

12. The device according to claim 7, further comprising:
a playing module, to search locally or the network for subtitle data corresponding to the video, and load the found subtitle data.

13. The method according to claim 2, wherein determining subtitle data matching the target dialogue comprises:
determining subtitle content matching the target dialogue; and
displaying at least one of the determined subtitle contents for the user, determining the subtitle data that a subtitle content selected by the user belongs as the subtitle data matching the target dialogue.

14. The method according to claim 2, wherein determining subtitle data matching the target dialogue comprises:
determining subtitle content matching the target dialogue; and
displaying the subtitle data that at least one determined subtitle content belongs to the user; and determining the subtitle data the user selects as the subtitle data corresponding to the target dialogue.

15. The method according to claim 3, wherein locating the video clip corresponding to the target dialogue in the video according to the matched subtitle data, comprises:
acquiring time points in the subtitle data matching the target dialogue;
locating the video clip corresponding to the target dialogue in the video according to the time points.

16. The device according to claim 8, wherein the matching module is further to determine subtitle contents corresponding to the target dialogue; and,
the interacting module id further to display the subtitle data that at least one determined subtitle content belongs for the user, the matching module is further to determine a subtitle data selected by the user as the subtitle data corresponding to the target dialogue.

17. The device according to claim 8, wherein the matching module is further to determine subtitle contents corresponding to the target dialogue and determine the subtitle data that the matched subtitle content belongs as the subtitle data corresponding to the target dialogue.

18. The device according to claim 9, wherein the locating module comprises:
a time point acquiring submodule, to acquire time points in the matched subtitle data; and
a position determining submodule, to locate the video clip corresponding to the target dialogue in this video according to the time points.
